(19) United States
(12) Patent Application Publication
(10) Pub. No.: US 2017/0262904 A1
(43) Pub. Date: Sep. 14, 2017

(54) WEIGHTED REVIEWS OF APPLICATIONS BASED ON USAGE HISTORY

(71) Applicant: Google Inc., Mountain View, CA (US)

(72) Inventors: Michael O'Herlihy, Mountain View, CA (US); Jeremy Drew Payne, San Jose, CA (US)

(21) Appl. No.: 15/066,670

(22) Filed: Mar. 10, 2016

(51) Int. Cl. G06Q 30/02

(52) U.S. Cl. CPC G06Q 30/0282

(57) ABSTRACT

A user review is weighted based on whether an application that has been reviewed is detected on the device used by the user. If the application is not detected on the device, then the review is given a zero or a relatively low weight. If the application is detected on the device, then a usage parameter associated with a history of prior use is determined, and a weight is assigned to the review based on the usage parameter. For example, a weight may be assigned to the review based on how many times the application has been opened, how many active uses the application has experienced on the device, the length of time the application has remained open, or the length of time the application has remained in active sessions prior to the review. The user review may be published with an indication of the weight accorded to that review.

### BACKGROUND

Reviews of software applications in application stores have been posted or published with little or no oversight as to the authenticity or seriousness of those reviews. As in any consumer or user reviews, some reviewers may have ulterior motives for reviewing applications in application stores. The reputation of an application developer may be unfairly tarnished by capricious reviewers who have not even used the application. In some instances, even if the reviewer has no ulterior motive against the developer, the reviewer may post a highly biased review without having used the application, or with only superficial or insubstantial use of the application.

### BRIEF SUMMARY

According to an embodiment of the disclosed subject matter, a method of weighting a user review of an application includes receiving the review from a user device, determining whether the application is in the user device, and assigning a first weight to the review if the application is not in the user device. In an embodiment, the method further includes determining a usage parameter based on one or more usages of the application by the user device if the application is in the user device, and assigning a second weight to the review based on the usage parameter, where the second weight is greater than the first weight.

According to an embodiment of the disclosed subject matter, an apparatus for weighting a user review of an application includes a memory and a processor communicably coupled to the memory. In an embodiment, the processor is configured to execute instructions to receive the review from a user device, to determine whether the application is in the user device, and to assign a first weight to the review if the application is not in the user device. In an embodiment, the processor is further configured to execute instructions to determine a usage parameter based on one or more usages of the application by the user device if the application is in the user device, and to assign a second weight to the review based on the usage parameter, where the second weight is greater than the first weight.

According to an embodiment of the disclosed subject matter, a server capable of communication with a user device through a network is provided. In an embodiment, the server includes a memory and a processor communicably coupled to the memory. In an embodiment, the processor is configured to execute instructions to receive a review of an application from a user device, to determine whether the application is in the user device, and to assign a first weight to the review if the application is not in the user device. In an embodiment, the processor is further configured to execute instructions to determine a usage parameter based on one or more usages of the application by the user device if the application is in the user device, and to assign a second weight to the review based on the usage parameter, where the second weight is greater than the first weight.

According to an embodiment of the disclosed subject matter, means for weighting a user review of an application are provided, which include means for receiving the review from a user device, means for determining whether the application is in the user device, and means for assigning a first weight to the review if the application is not in the user device. In an embodiment, the means for weighting the user review of the application further include means for determining a usage parameter based on one or more usages of the application by the user device if the application is in the user device, and means for assigning a second weight to the review based on the usage parameter, where the second weight is greater than the first weight.

Additional features, advantages, and embodiments of the disclosed subject matter may be set forth or apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows an example of a process of providing a weighted review of an application according to an embodiment of the disclosed subject matter.

FIG. 2 shows another example of a process of providing a weighted review of an application according to an embodiment of the disclosed subject matter.

FIG. 3 shows another example of a process of providing a weighted review of an application according to an embodiment of the disclosed subject matter.

FIG. 4 shows another example of a process of providing a weighted review of an application according to an embodiment of the disclosed subject matter.

FIG. 5 shows another example of a process of providing a weighted review of an application according to an embodiment of the disclosed subject matter.

FIG. 6 shows an example of a computing device according to an embodiment of the disclosed subject matter.

FIG. 7 shows an example of a network configuration according to an embodiment of the disclosed subject matter.

FIG. 8 shows an example of a system configuration according to an embodiment of the disclosed subject matter.

### DETAILED DESCRIPTION

The presently-disclosed subject matter relates to methods and apparatus for weighting user reviews of applications based on usage history. An “application” may include a computer program or software with an interface, such as a user interface, which may enable a user to accomplish a task on a computer or a user device, such as a smartphone, a tablet, or a smartwatch. The user interface for an application may include an icon on a touchscreen of a user device, for example. On various types of user devices, users may download and install various applications from an application store, for example. These applications may be developed by one or more software developers. Reviews by users of such applications may be published on a website, for example.

According to various embodiments of the disclosure, the review of an application by a user is weighted based on prior usage the application by the user on the user device. For example, upon receiving a review of the application from the user device, a determination is made as to whether the application is in the user device. As a specific example, such a determination may be made by the application store, which may detect whether the application has been downloaded from the application store by the user device. As another example, such a determination may be made by sending a query, through a wireless network, for example, to the user device, to detect whether the application is in the user device. If it is determined that the application is not in the user device, then a first weight, which may be a weight of zero or a relatively low weight, is assigned to that review.

On the other hand, if the application is in the user device, a usage parameter based on the usage of the application prior to receiving the review may be determined, and a second weight may be assigned to the review based on the usage parameter. The second weight, which is generated only if the application is in the user device, would be greater than the first weight, which corresponds to the non-presence of the application in the user device. The second weight may be scaled according to the usage parameter, which may be indicative of the user's experience or familiarity with the application. For example, the usage parameter may be based on the number of times the application is opened by the user on the user device prior to the review. As another example, the usage parameter may be based on the length of time the application is open prior to the review. As another example, if the application is opened and closed multiple times on the user device prior to the review, the usage parameter may be based on the total amount of time the application is open. As yet another example, the usage parameter may be based only on instances in which the application has remained open for at least a specific amount of time to determine the weight given to the review.

In some implementations, the service provider may detect the number of active sessions conducted by a given user device for a given application. For example, an active session may include a session in which a user performs one or more substantive tasks by using the application instead of by merely opening and closing the application, or by merely allowing the application to remain idle. In such implementations, the usage parameter may be based on the number of active sessions prior to the review instead of the number of times the application is opened by the user. As another example, the usage parameter may be based on the length of time during which the application is active prior to the review, instead of the total amount of time the application remains open. In some implementations, the usage parameter may be a function of some or all of these values.

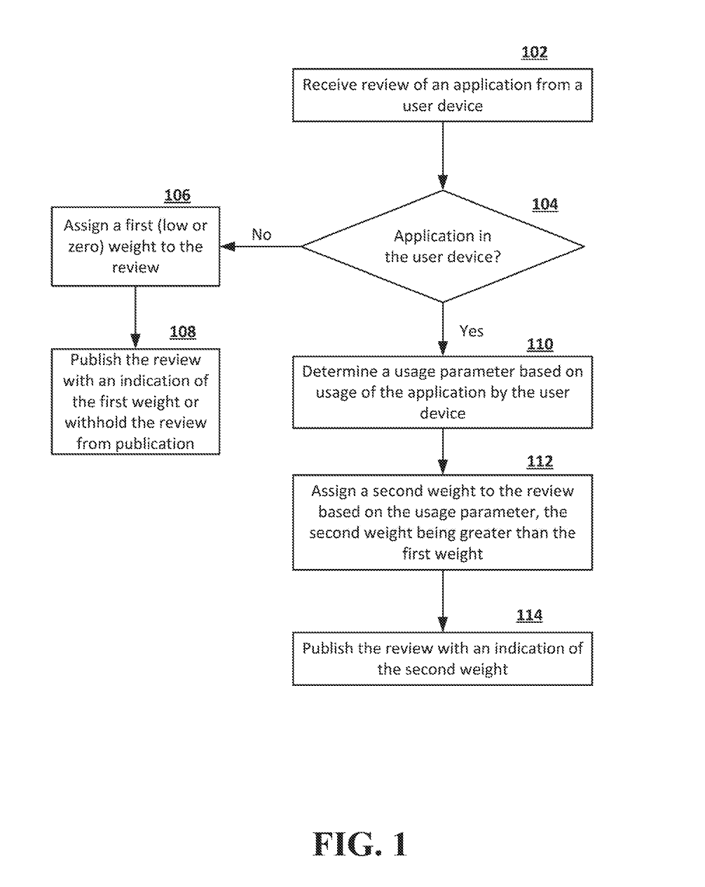

FIG. 1 is a flowchart illustrating an example of a process of providing a weighted review of an application according to an embodiment of the disclosed subject matter. A review of an application is received from a user device in block 102. A determination is made as to whether the application is in the user device in block 104. Such a determination may be made in various manners. For example, the application store may have knowledge of whether an individual user device has downloaded a certain application from the application store. The application store also may have knowledge of additional information, for example, the date and time the application was downloaded, the version of the application that was downloaded if there are multiple versions, whether the version of the application was a paid version or a free trial version, etc. As another example, the network or service provider may send a query to the user device, and attempt to detect a response from the user device indicating whether the application is in the user device.

If the application is not in the user device as determined in block 104, then a first weight is assigned to the review of the application in block 106. Because the application that has been allegedly reviewed is not in the user device, the review may be a fake or otherwise unreliable one and thus may be given no weight or a low weight. For example, if the weighting of a review is indicated by a five-star rating system, in which a five-star rating corresponds to the heaviest weight and a one-star rating corresponds to the lightest weight for user reviews, then a review received from a user device in which the application does not exist may be given a one-star rating. Alternatively, a review received from a user device in which the application does not exist may be rejected or withheld from publication. As shown in FIG. 1, upon assigning a low or zero weight to the review from a user device in which the application does not exist in block 106, the review may be published with an indication of a low weight or zero weight, or rejected or withheld from publication, as indicated in block 108.

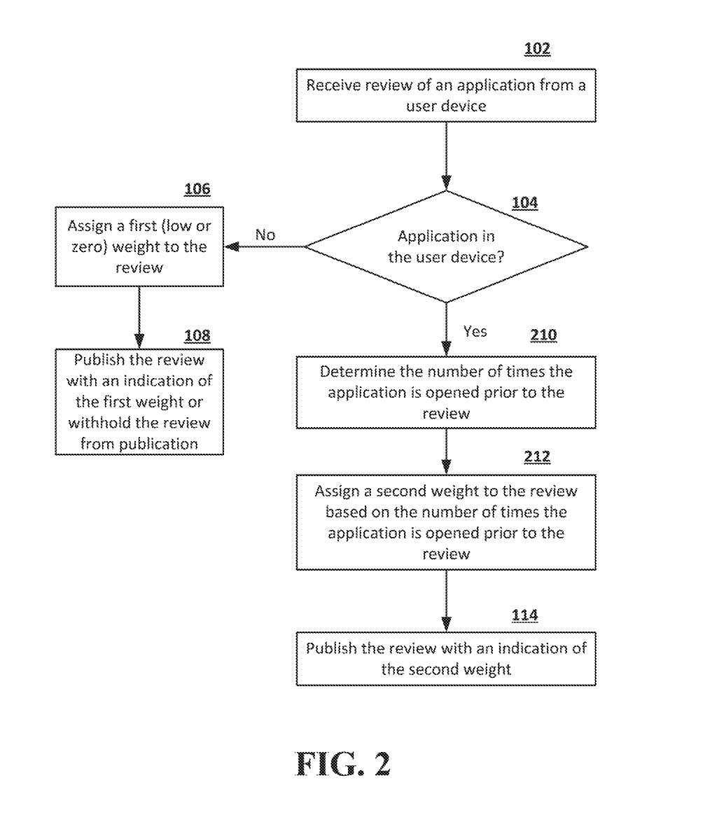

If, on the other hand, the application that has been allegedly reviewed is present in the user device as determined in block 104, then a usage parameter is determined based on usage of the application by the user device in block 110. The usage parameter may be an indication of the history of usage of the application in the user device prior to receiving the review, and such a usage parameter may be based on one or more types of information that may be detectable by the publisher of the review. Some specific examples of usage parameters that may be used in weighting a user review of the application are described below with references to FIGS. 2-5, although the subject matter of the disclosure is not limited to those specific examples.

In FIG. 1, after the usage parameter is determined in block 110, a second weight is assigned to the review based on the usage parameter in block 112. Because the second weight is assigned to the review only if it is determined that the application is in the user device in block 104, the second weight would be greater than the first weight, which may be a zero or low weight, assigned to the review in block 106 if the application is not in the user device. In an embodiment, the second weight that is assigned to the review in block 112 may be a quantity that is scaled to the usage parameter. For example, the second weight may be scaled proportionally to the usage parameter. The review may be published with an indication of the second weight in block 114. For example, a five-star rating system may be implemented, in which a one-star rating represents the lightest weight and a five-star rating represents the heaviest weight. Such a star rating may be placed next to each published user review, for example. As another example, a percentage rating system may be implemented in the publication of user reviews. In some implementations, on a website for the publication of user reviews, an explanation of the rating system for user reviews of applications may be provided to the public.

In some implementations, the user may legitimately enter a review from a device based on usage experience on another device. Such a review may be weighted as a legitimate review instead of being assigned a zero weight when the system detects that the application has been installed on another device owned or used by the user but not on the device on which the user submits the review. The system may determine the legitimacy of the review by reviewing the account profile of the user and comparing it with credentials the user has entered to submit the review, for example.

FIG. 2 is a flowchart illustrating another example of a process of providing a weighted review of an application according to an embodiment of the disclosed subject matter. Like the process shown in FIG. 1, a review of an application is received from a user device in block 102, and a determination is made as to whether the application is in the user device in block 104. The determination of whether the application exists in the user device may be made in various manners, some of which are described above with respect to FIG. 1. Such a determination may be made by obtaining knowledge of whether the user device has downloaded the application from an application store, for example, or by sending a query and attempting to detect a response from the user device indicating that the application exists in the user device.

Similar to the process shown in FIG. 1, if it is determined that the application is not in the user device in block 104 of FIG. 2, then a first weight, which may be a zero or low weight, is assigned to the review in block 106, and the review may be published with an indication of zero or low weight, or rejected or withheld from publication, as indicated in block 108. On the other hand, if it is determined that the application exists in the user device in block 104, then the number of times the application has been opened on the user device prior to receiving the review is determined in block 210. In this embodiment, the usage parameter may be the number of times the application has been opened on the user device prior to receiving the review, or a quantity that is related to the number of times the application has been opened prior to receiving the review. For example, the usage parameter may be a quantity that is proportional to the number of times the application has been opened on the user device prior to the review. Such a usage parameter may be indicative of the user's frequency of access to the application.

A high frequency of access may indicate a high likelihood that the user has gained much experience or familiarity with the application. In some implementations, uses of the application long before submitting the review may be disregarded or discounted. For example, the usage parameter may be limited to a certain time period prior to receiving the review. As a specific example, the number of times the user has opened the application only within one week or one month before submitting the review may be counted and used as a factor in determining the weight to be accorded to the review. In some implementations, after the system has received a number of reviews from a number of users, it may sort those reviews and publish them in an order that reflects the weights assigned to the reviews. For example, the review that is accorded the greatest weight may be published at the top, and the review that is accorded the least weight may be published at the bottom.

In FIG. 2, after the number of times the application has been opened prior to the review is determined in block 210, a second weight is assigned to the review based on the number of times the application has been opened in block 212. In an embodiment, the second weight that is assigned to the review in block 212 may be a quantity that is scaled to the number of times the application has been opened on the user device prior to receiving the review. For example, the second weight may be scaled proportionally to the number of times the application has been opened. In some implementations, only those instances in which the application has been opened within a certain period of time before submission of the review are taken into account in determining the second weight, such that old uses of the application would not influence the weighting of the review. The review may be published with an indication of the second weight in block 114. As described above with reference to FIG. 1, a rating that is indicative of the weight accorded to the review may be published along with the review in various manners, for example, by using a five-star rating system or a percentage rating system.

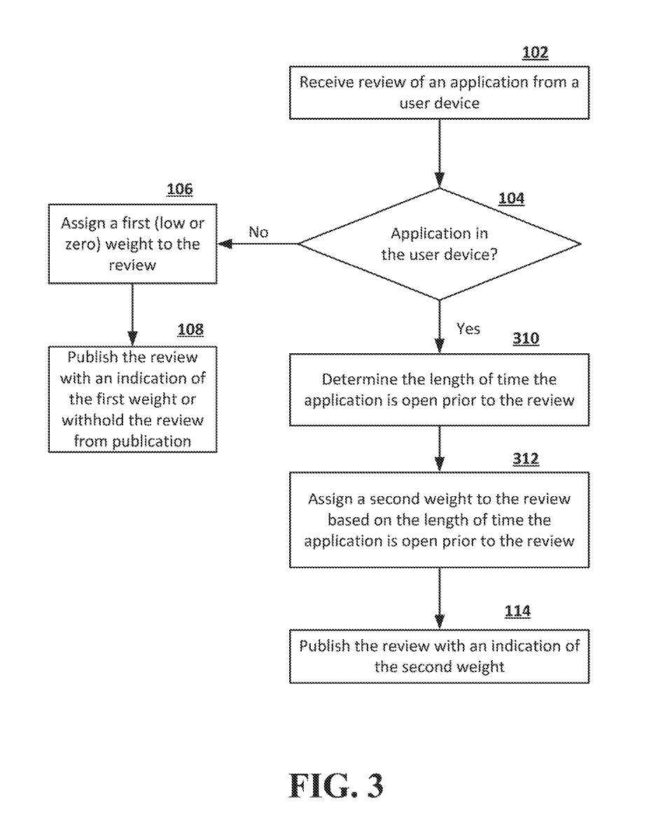

FIG. 3 is a flowchart illustrating another example of a process of providing a weighted review of an application according to an embodiment of the disclosed subject matter. Like the process shown in FIGS. 1 and 2, a review of an application is received from a user device in block 102, and a determination is made as to whether the application is in the user device in block 104. The determination of whether the application exists in the user device may be made in various manners, some of which are described above with respect to FIGS. 1 and 2. Such a determination may be made by obtaining knowledge of whether the user device has downloaded the application from an application store, for example, or by sending a query and attempting to detect a response from the user device indicating that the application exists in the user device.

Similar to the processes shown in FIGS. 1 and 2, if it is determined that the application is not in the user device in block 104 of FIG. 3, then a first weight, which may be a zero or low weight, is assigned to the review in block 106, and the review may be published with an indication of zero or low weight, or rejected or withheld from publication, as indicated in block 108. On the other hand, if it is determined that the application exists in the user device in block 104, then the length of time the application has remained open on the user device prior to receiving the review is determined in block 310. In this embodiment, the usage parameter may be the length of time the application has remained open on the user device prior to receiving the review, or a quantity that is related to the length of time the application has remained open prior to the review. For example, the usage parameter may be a quantity that is scaled proportionally to the length of time the application has remained open on the user device prior to the review.

If a user has kept the application open on the user device for a long period of time prior to submitting a review, the length of time during which the application remains open may be an indication that the user has used the application with seriousness, and thus a relatively great weight may be accorded to that review based on the length of time the application has remained open on the user device. In some situations, the user may have opened the application more than once prior to submitting the review, for example. In other words, there may be multiple instances in which the user has opened and closed the application, and the length of time the application has remained open in each instance may vary. In these situations, the length of time that is to be used as a factor in weighting the review may be the total length of time the application is open prior to submitting the review, for example. Alternatively, the length of time that is to be used as a factor in weighting the review may be the longest period of time the application has remained open continuously in a single instance of use prior to the review, for example. As another example, only those instances in which the user has opened the application within a limited period of time before submitting the review, for example, within one week or one month before submitting the review, may be used as a factor in determining the weight for that review, whereas instances of use prior to that period of time are disregarded. As yet another example, instances in which the application has remained open for only a short period of time before it is closed may be disregarded, because it may be unlikely that the user would have had sufficient time to gain more than a superficial understanding of the application in order to provide an informed opinion.

In FIG. 3, after the length of time the application has remained open prior to the review is determined in block 310, a second weight is assigned to the review based on the length of time the application has remained open in block 312. In an embodiment, the second weight that is assigned to the review in block 312 may be a quantity that is scaled to the length of time the application has remained open on the user device prior to receiving the review. For example, the second weight may be scaled proportionally to the length of time the application has remained open. Similar to the processes described above with references to FIGS. 1 and 2, the review may be published with an indication of the second weight in block 114, by using a rating system that corresponds to or is indicative of the weight accorded to that review, for example.

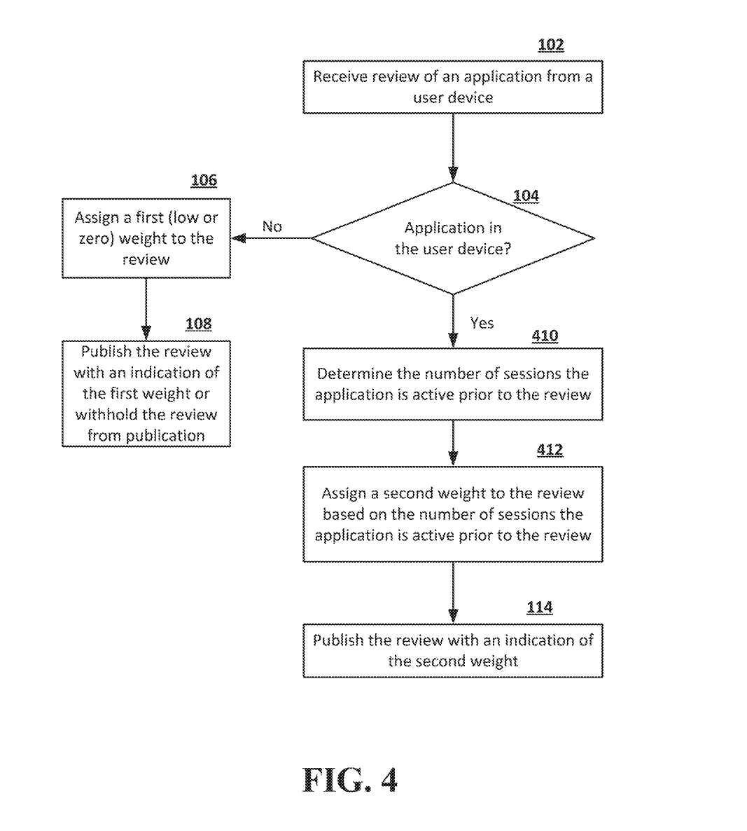

FIG. 4 is a flowchart illustrating another example of a process of providing a weighted review of an application according to an embodiment of the disclosed subject matter. In some situations, an application may remain open on a user device for a long period of time without any action or use by the user before it closes automatically. In some situations, the application may not close automatically but instead remain idle after a long period of non-use. In some situations, the application may be opened and closed multiple times without being actually used. In any of these situations, it may be desirable to base the weight for the review on the number of instances or the length of time of actual use.

In FIG. 4, a review of an application is received from a user device in block 102, and a determination is made as to whether the application is in the user device in block 104 in a manner similar to FIGS. 1-3 described above. If it is determined that the application is not in the user device in block 104 of FIG. 4, then a first weight, which may be a zero or low weight, is assigned to the review in block 106, and the review may be published with an indication of zero or low weight, or rejected or withheld from publication, as indicated in block 108. On the other hand, if it is determined that the application exists in the user device in block 104, then the number of active sessions the application has experienced on the user device prior to receiving the review is determined in block 410. In this embodiment, the usage parameter may be the number of active uses or sessions that have occurred prior to receiving the review, or a quantity that is related to the number of active uses or sessions. For example, the usage parameter may be a quantity that is scaled proportionally to the number of active uses or sessions prior to the review. In some implementations, not all active uses or sessions that have occurred prior to the review need to be taken into account for the weighting of the review. As an example, only the number of active uses or sessions within a limited period of time, for example, within one week or one month before submitting the review, may be used as a factor in determining the weight to be accorded to that review.

In FIG. 4, after the number of active uses or sessions that the application has experienced on the user device prior to the review is determined in block 410, a second weight is assigned to the review based on the number of active uses or sessions in block 412. In an embodiment, the second weight that is assigned to the review in block 412 may be a quantity that is scaled to the number of active uses or sessions prior to receiving the review. For example, the second weight may be scaled proportionally to the number of active uses or sessions. After the second weight is determined in block 412, the review may be published with an indication of the second weight in block 114. As described above with references to FIGS. 1-3, a rating that indicates the weight accorded to the review may be published along with the review in various manners, for example, by using a five-star rating system or a percentage rating system.

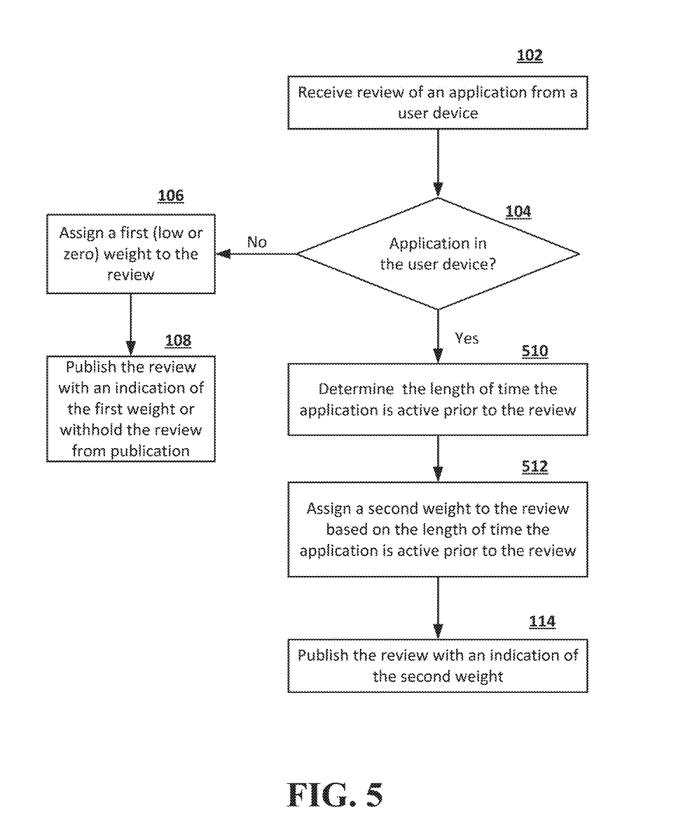

FIG. 5 is a flowchart illustrating yet another example of a process of providing a weighted review of an application according to an embodiment of the disclosed subject matter. Like the processes shown in FIGS. 1-4, a review of an application is received from a user device in block 102, and a determination is made as to whether the application is in the user device in block 104. The determination of whether the application exists in the user device may be made in various manners, some of which are described above with respect to FIGS. 1-4. Similar to the processes shown in FIGS. 1-4, if it is determined that the application is not in the user device in block 104 of FIG. 5, then a first weight, which may be a zero or low weight, is assigned to the review in block 106, and the review may be published with an indication of zero or low weight, or rejected or withheld from publication, as indicated in block 108. On the other hand, if it is determined that the application exists in the user device in block 104, then the length of time the application has remained active on the user device prior to receiving the review is determined in block 510. In this embodiment, the usage parameter may be the length of time the application has remained active on the user device prior to receiving the review, or a quantity that is related to the length of time the application has remained active. For example, the usage parameter may be a quantity that is proportional to the length of time the application has remained active on the user device prior to the review.

In some situations, there may be multiple instances in which the user has actively used the application. In such situations, the total length of time over multiple instances of active use may applied as a usage parameter for determining the weight to be accorded to the review, for example. Alternatively, the longest time of active use over a single instance of use prior to the review may be applied as a usage parameter for determining the weight, for example. As another example, only the length of time of active use within a limited period of time before submitting the review, for example, within one week or one month before submitting the review, may be used as a factor in determining the weight for that review, whereas instances of active use prior to that period of time are disregarded.

In FIG. 5, after the length of time of active use of the application prior to the review is determined in block 510, a second weight is assigned to the review based on the length of time of active use in block 512. In an embodiment, the second weight that is assigned to the review in block 512 may be a quantity that is scaled to the length of time of active use prior to receiving the review. For example, the second weight may be scaled proportionally to the length of time the application is active. Similar to the processes described above with references to FIGS. 1-4, the review may be published with an indication of the second weight in block 114, by using a rating system that corresponds to or is indicative of the weight accorded to that review, for example.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. As another example, although the identity of the device in which an application has been installed and used may be used for weighting a review received from that device, personal information associated with the user of that device may not be necessary for a system to provide a weighting of that review. Thus, the user may have control over how information is collected about the user and used by a system as disclosed herein.

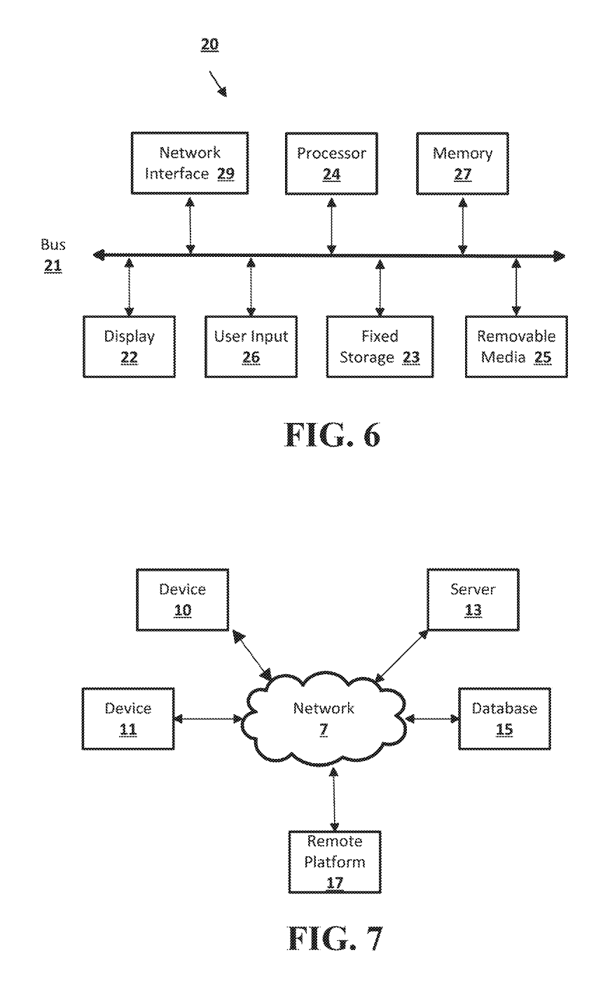

Embodiments of the presently disclosed subject matter may be implemented in and used with a variety of component and network architectures. FIG. 6 is an example of a computing device 20 suitable for implementing embodiments of the presently disclosed subject matter. The device 20 may be, for example, a user device such as a desktop or laptop computer, or a mobile computing device such as a smart phone, tablet, or the like. In some implementations, the device 20 may be a computer or an application store server that determines usage parameters based on histories of application usage on user devices and assigns weights to user reviews based on the usage parameters. The device 20 may include a bus 21 which interconnects major components of the computer 20, such as a central processor 24, a memory 27 such as Random Access Memory (RAM), Read Only Memory (ROM), flash RAM, or the like, a user display 22 such as a display screen, a user input interface 26, which may include one or more controllers and associated user input devices such as a keyboard, mouse, touch screen, and the like, a fixed storage 23 such as a hard drive, flash storage, and the like, a removable media component 25 operative to control and receive an optical disk, flash drive, and the like, and a network interface 29 operable to communicate with one or more remote devices via a suitable network connection.

The bus 21 allows data communication between the central processor 24 and one or more memory components, which may include RAM, ROM, and other memory, as previously noted. Typically RAM is the main memory into which an operating system and application programs are loaded. A ROM or flash memory component can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium.

The fixed storage 23 may be integral with the computer 20 or may be separate and accessed through other interfaces. The network interface 29 may provide a direct connection to a remote server via a wired or wireless connection. The network interface 29 may provide such connection using any suitable technique and protocol as will be readily understood by one of skill in the art, including digital cellular telephone, Wi-Fi, Bluetooth®, near-field, and the like. For example, the network interface 29 may allow the computer to communicate with other computers via one or more local, wide-area, or other communication networks, as described in further detail below.

Many other devices or components (not shown) may be connected in a similar manner (e.g., document scanners, digital cameras and so on). Conversely, all of the components shown in FIG. 6 need not be present to practice the present disclosure. The components can be interconnected in different ways from that shown. The operation of a computer such as that shown in FIG. 6 is readily known in the art and is not discussed in detail in this application. Code to implement the present disclosure can be stored in computer-readable storage media such as one or more of the memory 27, fixed storage 23, removable media 25, or on a remote storage location.

FIG. 7 shows an example of a network configuration according to an embodiment of the disclosed subject matter. One or more devices 10, 11, such as user devices, local computers, smart phones, tablet computing devices, and the like may connect to other devices via one or more networks 7. Each device may be a computing device as previously described. The network may be a local network, wide-area network, the Internet, or any other suitable communication network or networks, and may be implemented on any suitable platform including wired and/or wireless networks. The devices may communicate with one or more remote devices, such as servers 13 and/or databases 15. The remote devices may be directly accessible by the devices 10, 11, or one or more other devices may provide intermediary access such as where a server 13 provides access to resources stored in a database 15. The devices 10, 11 also may access remote platforms 17 or services provided by remote platforms 17 such as cloud computing arrangements and services. The remote platform 17 may include one or more servers 13 and/or databases 15. In some implementations, the server 13 may be an application store server that is capable of performing any of the processes of FIGS. 1-5 described above.

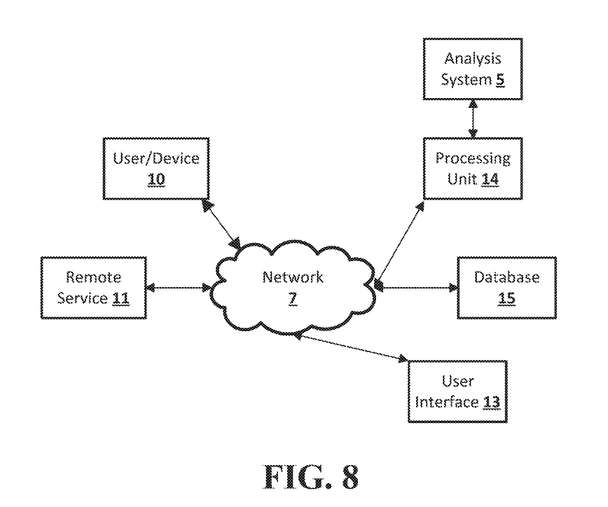

FIG. 8 shows an example of a system configuration according to an embodiment of the disclosed subject matter. One or more devices or systems 10, 11, such as remote services or service providers 11, user devices 10 such as local computers, smart phones, tablet computing devices, and the like, may connect to other devices via one or more networks 7. The network may be a local network, wide-area network, the Internet, or any other suitable communication network or networks, and may be implemented on any suitable platform including wired and/or wireless networks. The devices 10, 11 may communicate with one or more remote computer systems, such as processing units 14, databases 15, and user interface systems 13. In some cases, the devices 10, 11 may communicate with a user-facing interface system 13, which may provide access to one or more other systems such as a database 15, a processing unit 14, or the like. For example, the user interface 13 may be a user-accessible web page that provides data from one or more other computer systems. The user interface 13 may provide different interfaces to different clients, such as where a human-readable web page is provided to a web browser client on a user device 10, and a computer-readable API or other interface is provided to a remote service client 11.

The user interface 13, database 15, and/or processing units 14 may be part of an integral system, or may include multiple computer systems communicating via a private network, the Internet, or any other suitable network. One or more processing units 14 may be, for example, part of a distributed system such as a cloud-based computing system, search engine, content delivery system, or the like, which may also include or communicate with a database 15 and/or user interface 13. In some arrangements, an analysis system 5 may provide back-end processing, such as where stored or acquired data is pre-processed by the analysis system 5 before delivery to the processing unit 14, database 15, and/or user interface 13. For example, a machine learning system 5 may provide various prediction models, data analysis, or the like to one or more other systems 13, 14, 15. In some implementations, any computing device associated with the network 7, such as the analysis system 5, the remote service client 11, or the processing unit 14, may perform any of the processes of FIGS. 1-5 described above.

More generally, various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, such that when the computer program code is loaded into and executed by a computer, the computer becomes an apparatus for practicing embodiments of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, such that when the computer program code is loaded into and executed by a computer, the computer becomes an apparatus for practicing embodiments of the disclosed subject matter. When implemented on a general-purpose microprocessor, the computer program code segments configure the microprocessor to create specific logic circuits.

In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A method comprising:
receiving a review of an application from a user device;
determining whether the application is in the user device;
assigning a first weight to the review if the application is not in the user device;
determining a usage parameter based on one or more usages of the application by the user device if the application is in the user device; and
assigning a second weight to the review based on the usage parameter, wherein the second weight is greater than the first weight.

2. The method of claim 1, further comprising providing the review for display in association with information about the application, the display of the review being affected by at least the second weight.

3. The method of claim 1, wherein the first weight is a weight of zero.

4. The method of claim 1, wherein the usage parameter is based on a number of times the application is opened prior to receiving the review.

5. The method of claim 1, wherein the usage parameter is based on a length of time the application is open prior to receiving the review.

6. The method of claim 1, wherein the usage parameter is based on a number of active uses of the application prior to receiving the review.

7. The method of claim 1, wherein the usage parameter is based on a length of time the application is active prior to receiving the review.

8. The method of claim 1, further comprising withholding the review from publication if the application is not in the user device.

9. The method of claim 1, wherein the application is one of a plurality of applications available from an application store.

10. An apparatus comprising:
a memory; and
a processor communicably coupled to the memory, the processor configured to execute instructions to:
receive a review of an application from a user device;
determine whether the application is in the user device;
assign a first weight to the review if the application is not in the user device;
determine a usage parameter based on one or more usages of the application by the user device if the application is in the user device; and
assign a second weight to the review based on the usage parameter, wherein the second weight is greater than the first weight.

11. The apparatus of claim 10, wherein the first weight is a weight of zero.

12. The apparatus of claim 10, wherein the usage parameter is based on a number of times the application is opened prior to receiving the review.

13. The apparatus of claim 10, wherein the usage parameter is based on a length of time the application is open prior to receiving the review.

14. The apparatus of claim 10, wherein the usage parameter is based on a number of active uses of the application prior to receiving the review.

15. The apparatus of claim 10, wherein the usage parameter is based on a length of time the application is active prior to receiving the review.

16. A server capable of communication with a user device through a network, the server comprising:
a memory; and
a processor communicably coupled to the memory, the processor configured to execute instructions to:
receive a review of an application from a user device;
determine whether the application is in the user device;
assign a first weight to the review if the application is not in the user device;
determine a usage parameter based on one or more usages of the application by the user device if the application is in the user device; and
assign a second weight to the review based on the usage parameter, wherein the second weight is greater than the first weight.

17. The apparatus of claim 16, wherein the usage parameter is based on a number of times the application is opened prior to receiving the review.

18. The apparatus of claim 16, wherein the usage parameter is based on a length of time the application is open prior to receiving the review.

19. The apparatus of claim 16, wherein the usage parameter is based on a number of active uses of the application prior to receiving the review.

20. The apparatus of claim 16, wherein the usage parameter is based on a length of time the application is active prior to receiving the review.
